(19) United States
(12) Patent Application Publication
(10) Pub. No.: US 2013/0207500 A1
(43) Pub. Date: Aug. 15, 2013

(54) THREE-PHASE ALTERNATING CURRENT PERMANENT MAGNET MOTOR

(71) Applicant: Lei Bi, Singapore City (SG)

(72) Inventor: Lei Bi, Singapore City (SG)

(73) Assignee: FORTIOR TECHNOLOGY (SHENZHEN) CO., LTD., Shenzhen P.R. (CN)

(21) Appl. No.: 13/808,552

(22) PCT Filed: Jul. 8, 2010
(86) PCT No.: PCT/CN2010/075062

§ 371 Date: Jan. 22, 2013

(30) Foreign Application Priority Data
Jul. 6, 2010 (CN) 201010219190.8

(51) Int. Cl. H02K 1/27

(52) U.S. Cl. CPC H02K 1/27
USPC 310/156.41; 310/156.01; 310/156.38

(57) ABSTRACT

A three-phase PMAC motor comprises a rotor and a stator. The rotor includes a rotor iron core, a plurality of rotor teeth, a plurality of rotor slots each formed between two adjacent rotor teeth, and a plurality of permanent magnets disposed in respective rotor slots and attached on the rotor iron core. The plurality of permanent magnets forms at least 8 pairs of magnet poles with one or two permanent magnets being associated with one pair of magnetic poles. The stator includes a stator iron core, a plurality of stator teeth protruding inwardly from inner surface of the stator iron core, three groups of armature windings wound around each of the stator teeth, and a plurality of stator slots formed between two adjacent stator teeth. Each group of armature windings is associated with one electrical phase. An electrical phase shift exists between each two armature windings.

### CROSS-REFERENCE TO RELATED APPLICATION

This application is a continuation-in-part of International Application No. PCT/CN2010/075062, filed on Jul. 8, 2010, which claims the benefit of Chinese Patent Application No. 201010219190.8, filed on Jul. 6, 2010, the contents of which are incorporated herein by reference in their entireties.

### TECHNICAL FIELD

The example embodiments of the present invention generally relate to a motor, more particularly to a three-phase permanent-magnet alternating current motor.

### BACKGROUND

With development of electronic technology, sensor technology, control technology and materials science, three-phase permanent-magnet alternating current (PMAC) motors have been widely used in many applications.

A PMAC motor may include armature windings in a stator and a plurality of permanent magnets in a rotor with an air gap between the stator and the rotor. The permanent magnets may generate a magnetic field. When the magnetic field reaches saturation, current flowing through the armature windings may significantly influence air gap field resulting in armature reaction. Armature reaction has large effect on torque coefficient. To reduce effect of armature reaction on the torque coefficient, many three-phase alternating current PMAC motors employ a surface mounted magnetic (SMM) structure. When permanent magnet motors use the SMM structure, the permanent magnets are attached to the surface of the armature.

Main magnetic reluctance of the permanent magnets changes when rotor rotates in different positions thus generating cogging torque. In rotating electrical machines with eccentric rotor, an imbalance of the electromagnetic forces acting upon rotor and stator surfaces occurs, so that a force is developed. This force is known as unbalanced magnetic pull (UMP). Cogging torque and UMP cause vibrations and noise emission and may produce a rub between rotor and stator with a consequent damage of the windings. It is desired to minimize the cogging torque and UMP caused by the magnetic forces developed in permanent magnets.

However, cogging torque and UMP may not be minimized simultaneously. For example, a conventional three-phase PMAC motor that includes 6 stator slots and 4 magnetic pole-pairs may have low UMP but relatively high cogging torque. A cogging torque diagram is shown in FIG. 1. To reduce the cogging torque, many three-phase PMAC motors employ 9 stator slots and 4 magnetic pole-pairs, as shown in FIG. 2. Although this structure can reduce the cogging torque, the UMP may still be produced. As shown in FIG. 3, drive current may be an UMP source and may have more serious effect on the UMP. Therefore, three-phase PMAC motors cannot reduce the effects of cogging torque and UMP simultaneously.

### BRIEF SUMMARY

According to one exemplary embodiment of the present invention, a three-phase PMAC motor comprises a rotor and a stator. The rotor includes a rotor iron core, a plurality of rotor teeth, a plurality of rotor slots each formed between two adjacent rotor teeth, and a plurality of permanent magnets disposed in respective rotor slots and attached on the rotor iron core. The plurality of permanent magnets forms at least 8 pairs of magnet poles with one or two permanent magnets being associated with one pair of magnetic poles. The stator includes a stator iron core, a plurality of stator teeth protruding inwardly from inner surface of the stator iron core, three groups of armature windings wound around each of the stator teeth, and a plurality of stator slots formed between two adjacent stator teeth. Each group of armature windings is associated with one electrical phase. An electrical phase shift exists between each two armature windings.

### BRIEF DESCRIPTION OF THE DRAWING(S)

FIG. 1 shows cogging torque of a three-phase PMAC motor having 6 stator slots and 4 magnetic pole-pairs;

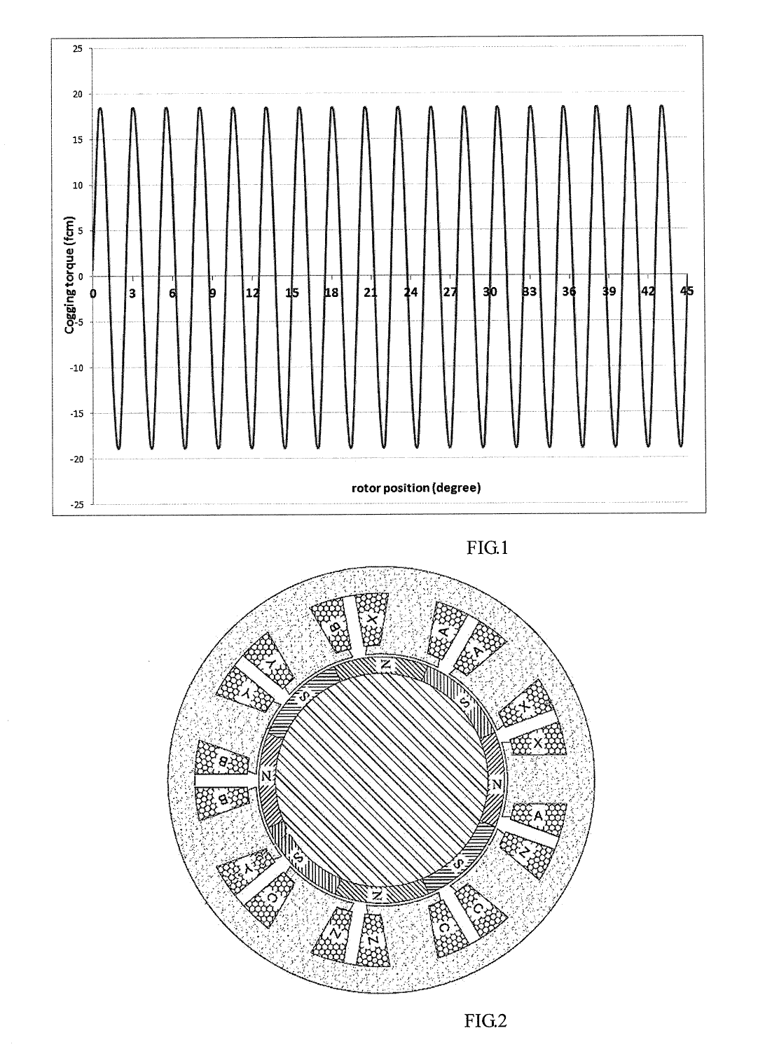

FIG. 2 shows a three-phase PMAC motor having 9 stator slots and 4 rotor magnetic pole-pairs;

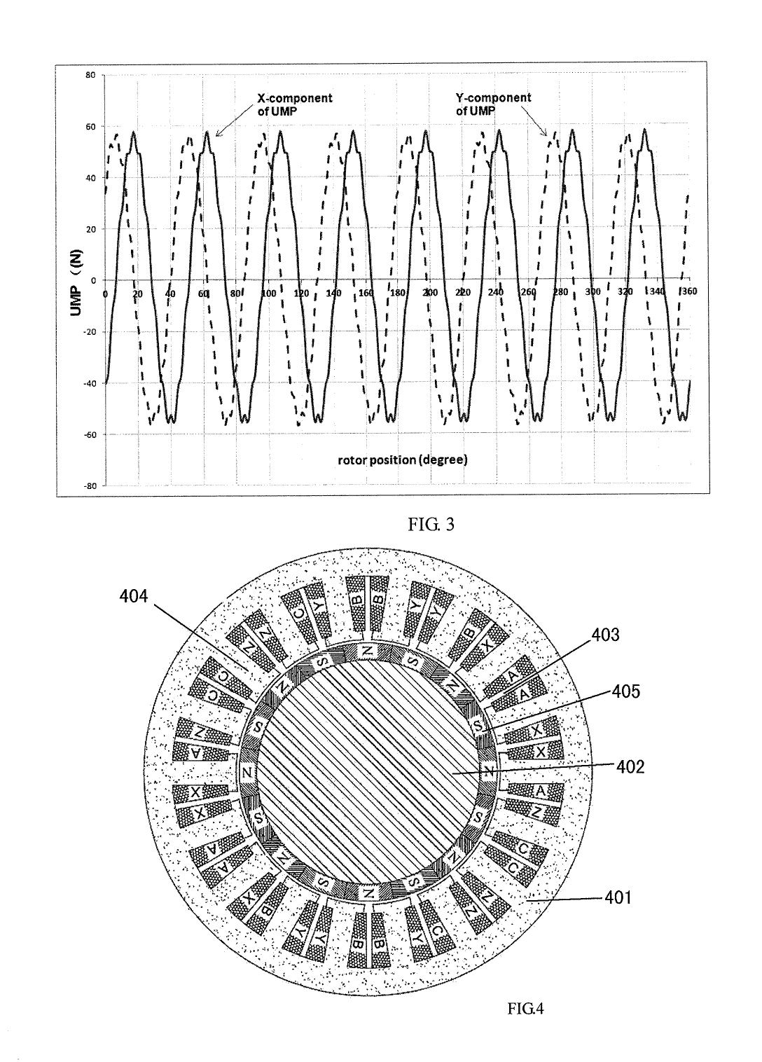

FIG. 3 shows UMP of a three-phase PMAC motor having 9 stator slots and 4 rotor magnetic pole-pairs;

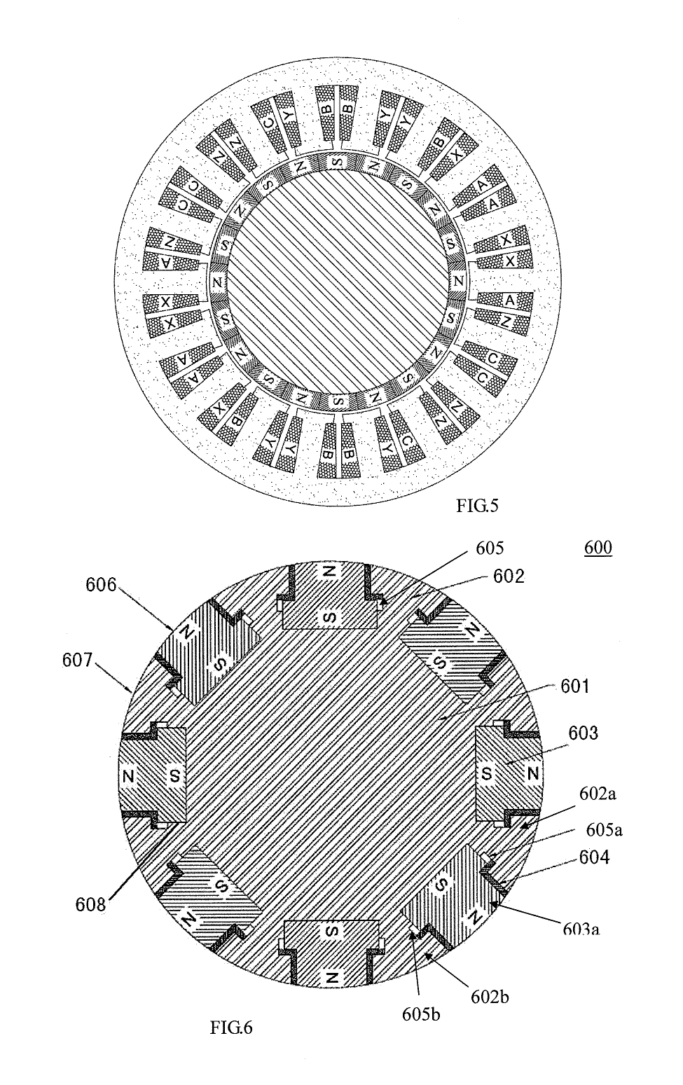

FIGS. 4 and 5 show an exemplary three-phase PMAC motor in accordance with exemplary embodiments;

FIG. 6 shows an exemplary rotor of a three-phase PMAC in accordance with an exemplary embodiment;

FIG. 7 shows a magnetic field generated by the exemplary three-phase PMAC motor shown in FIG. 6; and

FIGS. 8-14 show exemplary rotors in accordance with exemplary embodiments.

### DETAILED DESCRIPTION OF THE EMBODIMENTS

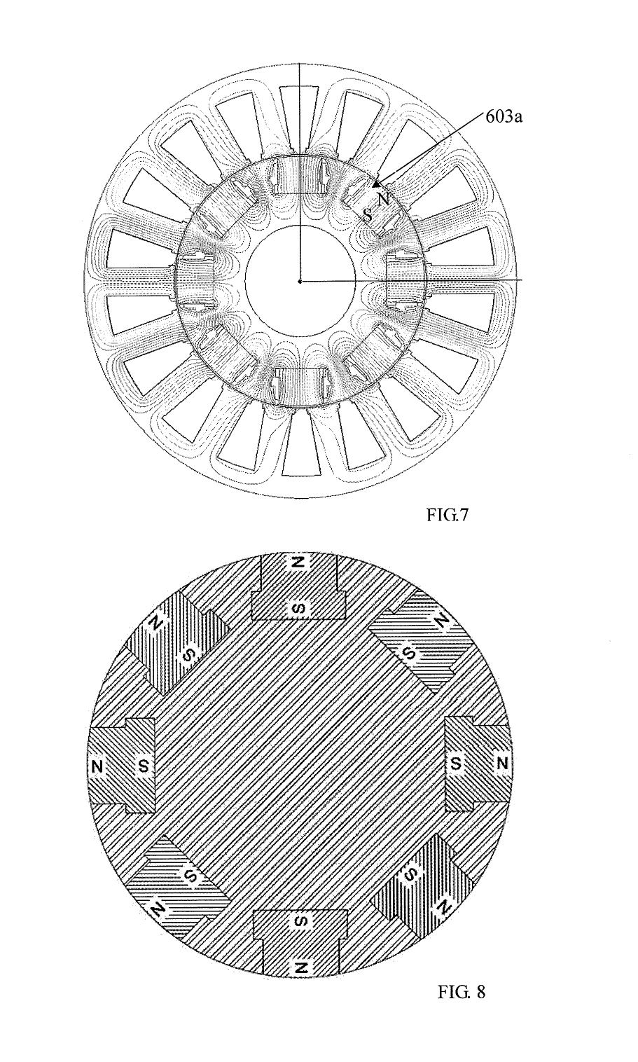

FIG. 4 shows an exemplary three-phase PMAC motor in accordance with an exemplary embodiment. A three-phase PMAC motor comprises a stator (not numbered) and a rotor (not numbered). Each of the rotor and stator may have various structures depending on various applications. The exemplary stator illustrated in FIG. 4 includes a stator iron core 401, a plurality of stator teeth 404 protruding inwardly from inner surface of the stator iron core 401, three groups of armature windings (for example, armature windings A, B and C each group corresponding to an electrical phase) wound around the stator teeth 404, and a plurality of stator slots 403 formed between two adjacent stator teeth 404. The number of armature windings that is associated with one electrical phase may vary according to various embodiments. In this embodiment, the number of armature windings that is associated with one electrical phase may be about 6. As such, the number of three-phase armature windings is 18. Correspondingly, the number of stator slots 403 is 18. Each armature winding may have multiple coils. For example, each of the armature windings A, B and C may include two coils. Each of the coils may be wound around its associate stator tooth in a similar manner. Of course, they may be wound in different manners. The two coils of each armature winding (e.g., A, B, C) may be wound in series or parallel. Armature windings A, B and C may have various winding line connection patterns. For example, the winding line connection pattern may be half-wave wye, full-wave wye, delta, and/or the independent winding line connections. External current may be provided to the armature windings. The current may flow into the stator from coils A-A to X-A, from coils B-B to Y-B, and from coils C-C to Z-C.

The rotor includes a rotor iron core 402 and a plurality of permanent magnets 405 attached on the rotor iron core 402, in which the polarities of the permanent magnets are alternately arranged along the circumferential direction in the rotor iron core 402 to achieve a magnetic field. One or two permanent magnets may form a pair of magnetic poles. In this embodiment, each pair of magnetic poles is associated with two permanent magnets with opposite polarities. The number of the magnetic poles may vary according to various embodiments. For example, in the embodiment shown in FIG. 4, the rotor includes 16 permanent magnets (e.g. 405). Because each permanent magnet forms one magnetic pole there are 16 magnetic poles. In another embodiment shown in FIG. 5, the rotor includes 20 permanent magnets forming 20 magnetic poles. The permanent magnets shown in FIG. 5 are arranged in a similar manner as that of FIG. 4. However, the permanent magnets may be arranged in different manners which will be described in detail below. Cycle of cogging torque may vary with the number of magnetic poles. For example, in the embodiment illustrated in FIG. 4, the cycle of cogging torque may be about 2.5°. In the embodiment illustrated in FIG. 5, the cycle of cogging torque may be about 2°. Although the permanent magnets shown in FIG. 4 are of arc shape, they may have any other shapes, such as rectangular shape.

The permanent magnets 405 can be attached to the rotor by various methods, for example, by applying adhesives between each permanent magnet and inner surface of the rotor. In other embodiments, permanent magnets can also be attached to the rotor by other suitable methods which will be described in detail below.

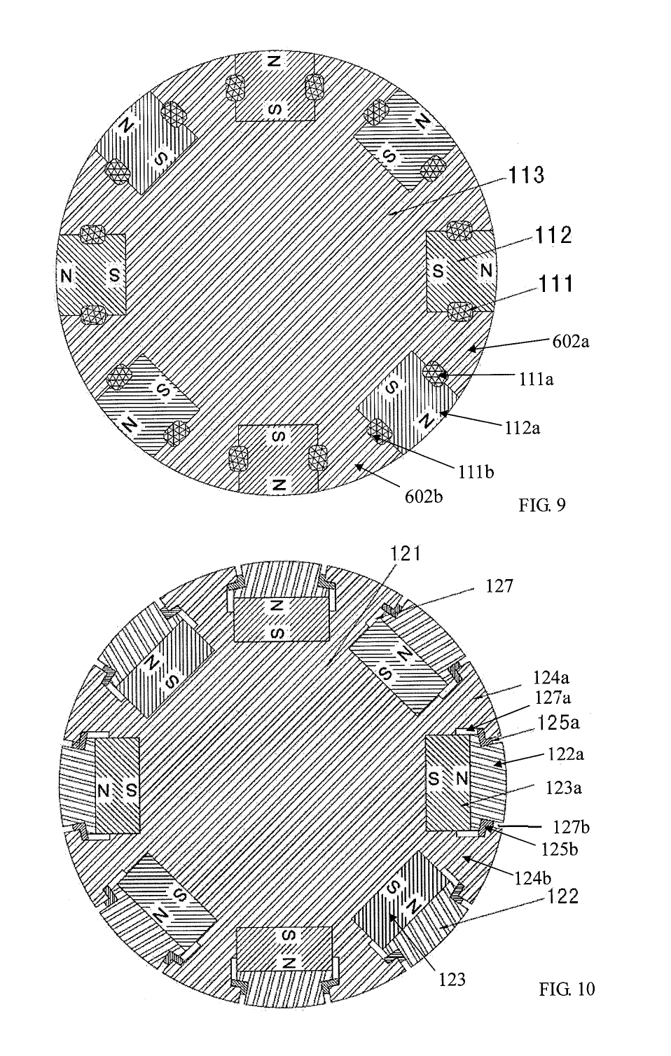

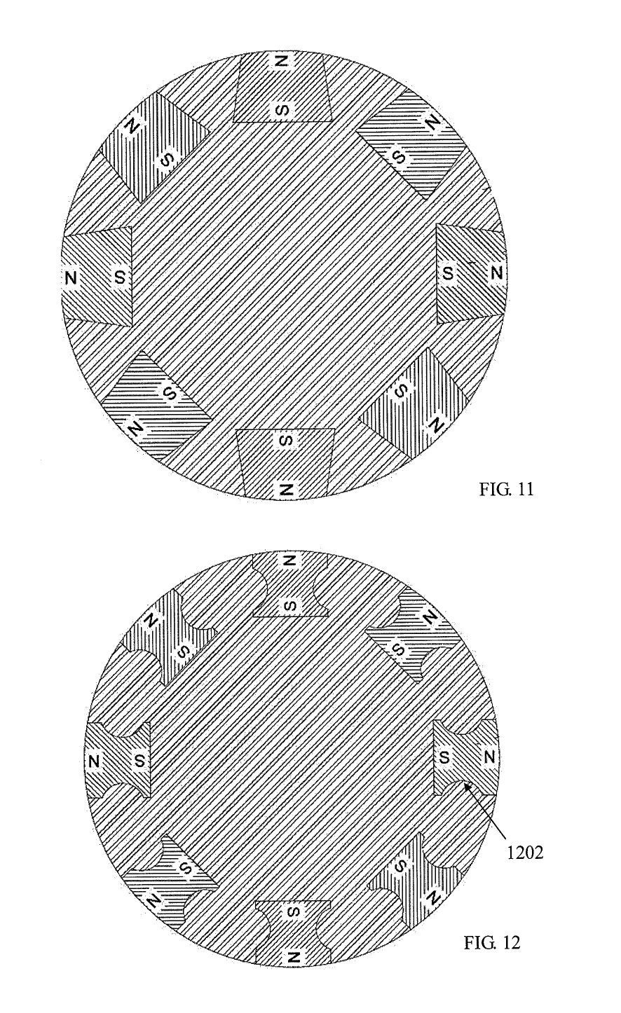

As described above, permanent magnets can be attached to the rotor by applying adhesives but can also be attached to the rotor by other methods. FIG. 6 illustrates an exemplary rotor 600 including a rotor iron core 601, a plurality of rotor teeth 602, a plurality of rotor slots 608 each formed between two adjacent rotor teeth (e.g., 602a, 602b), and a plurality of permanent magnets 603 disposed in respective rotor slots and attached on the rotor iron core 601. Each permanent magnet is separated from its adjacent rotor teeth by forming spaces 605 between sidewalls of each permanent magnet and its adjacent rotor teeth. For example, sidewalls of permanent magnet 603a are separated from its adjacent teeth 602a and 602b by spaces 605a and 605b respectively. The permanent magnets 603 may be attached on the rotor iron core 601 by filling part of each space 605 with non-magnetic materials 604. The non-magnetic materials 604 can be stainless steel, aluminum, copper, plastic sheet, and/or any other suitable non-magnetic materials. The permanent magnets 603 are arranged circumferentially on inner surface of the rotor 600 with north pole and south pole disposed on radial direction. As a result of such an arrangement, each permanent magnet forms a pair of magnetic poles. Diagram of the magnetic field produced by the permanent magnets is illustrated in FIG. 7. As shown in FIG. 7, each permanent magnet (e.g., 603a) forms a pair of magnetic poles (North and South). Thus, the number of the permanent magnets is equivalent to the number of pairs of magnetic poles. Compared to the structures illustrated in FIGS. 4 and 5, permanent magnets in this embodiment are not attached to outer surface of the rotor iron core, but disposed in respective slots formed in the rotor iron core. Such an arrangement can achieve high-precision surface 606 of permanent magnets as well as high-precision surface 607 of rotor teeth. Although FIG. 6 shows that South pole of each permanent magnet is disposed closer to the core of the rotor 600 than North pole on radial direction, it is not limited to this arrangement. The permanent magnets can be disposed by switching South pole and North pole on radial direction. In this embodiment, the cycle of cogging torque may be about 5°.

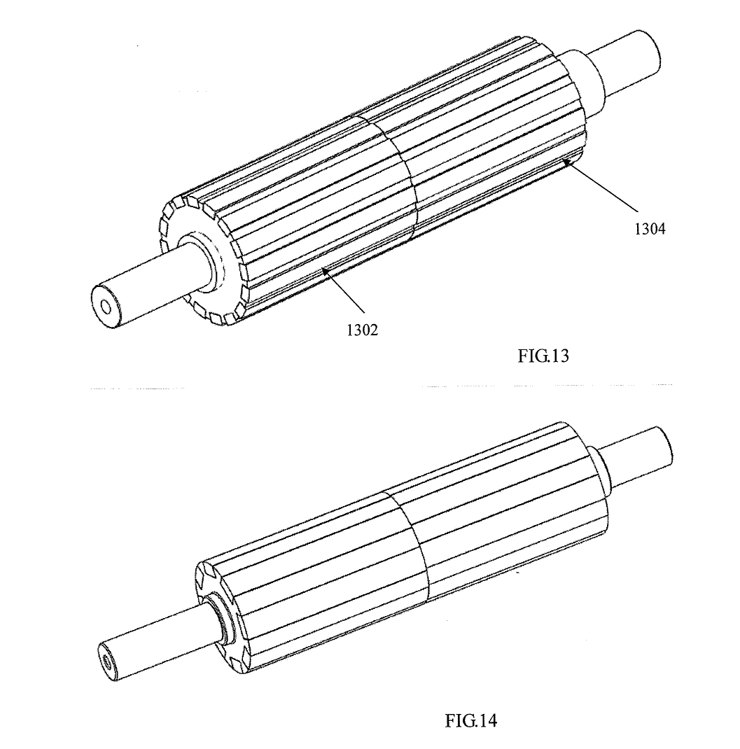

In another embodiment, there may be no spaces formed between sidewalls of each permanent magnet and its adjacent rotor teeth, as shown in FIG. 8. As such, no non-magnetic material is filled therebetween.

Methods of attaching permanent magnets to the rotor are also illustrated in FIGS. 9 and 10. As shown in FIG. 9, permanent magnets 112 are attached to rotor iron core 113 by a plurality of bolts 111. For example, bolts 111a and 111b are inserted into respective recesses (not numbered) formed on sidewalls of the permanent magnet 112a and its adjacent rotor teeth 602a and 602b thus attaching the permanent magnet 112a to the rotor iron core 113. The connections by bolts between the permanent magnets and their adjacent teeth allow the permanent magnets to rotate with respect to a stator (not shown).

FIG. 10 illustrates another method of attaching permanent magnets 123 to rotor iron core 121. In this embodiment, each permanent magnet 123 is hold and attached to the rotor iron core 121 by employing a magnetic cap 122. Each of the magnetic caps (e.g., 122a) is isolated from its respective adjacent rotor teeth (e.g., 124a and 124b) by corresponding spaces (e.g., 127a and 127b) to prevent eddy currents loss and magnetic leakage. The magnetic caps 122 may include soft magnetic materials. The magnetic caps 122 are secured to the rotor iron core 121 by filling portion of each space with non-magnetic materials (e.g., 125a and 125b).

As described in FIGS. 6, 9 and 10, when permanent magnets are arranged circumferentially on inner surface of the rotor with North pole and South pole disposed on the radial direction, the permanent magnets may have various shapes depending on shapes of rotor slots. The permanent magnets may or may not have the same shape as that of the slots by employing magnetic fillings (e.g., magnetic cap 122 shown in FIG. 10) on the outer surface of each permanent magnet. In this regard, each rotor slot receives both permanent magnet and magnetic fillings. Shape of the rotor slots is not limited to rectangular and T-shape. It can be other shapes, such as trapezoid (shown in FIG. 11), triangular, polygon, arc, and/or any other shapes. The permanent magnets may also have curves on sidewalls (for example, the permanent magnets with curves 1202 on sidewalls shown in FIG. 12). In some embodiments, the permanent magnets can be attached to the rotor iron core by simply inserting the permanent magnets into rotor slots, as shown in FIGS. 8, 11 and 12. In other embodiments, the permanent magnets can be attached to the rotor iron core by filling non-magnetic materials in spaces between sidewalls of permanent magnets and rotor iron core (for example, as shown in FIG. 6), or by employing magnetic fillings (e.g., magnetic caps 122 shown in FIG. 10) which is in turn attached to the rotor iron core by filling non-magnetic materials (e.g., 125a, 125b in FIG. 10) in spaces (e.g., 127a, 127b in FIG. 10) between the sidewalls of magnetic fillings and the rotor iron core. The permanent magnets can also be attached to the rotor iron core by a plurality of bolts (as shown in FIG. 9). Similar to shapes of the rotor slots, shapes of the permanent magnets, magnetic fillings, spaces and bolts are not limited to what described above, they may also vary according to various applications.

In other embodiments, there may be two or more rotor stages in longitudinal direction. Each rotor stage includes a rotor iron core to which a plurality of permanent magnets is attached. One embodiment shown in FIG. 13 includes a first and second rotor stages 1302 and 1304. Each rotor stage includes a plurality of permanent magnets. To reduce fundamental wave of the cogging torque, there is an electrical phase shift (e.g., 180°) between adjacent rotor stages (e.g., 1302 and 1304). In one embodiment, as shown in FIG. 13, each rotor stage may include 16 permanent magnets inserted into respective 16 rotor slots. There are 16 rotor teeth each of which separates two adjacent rotor slots. In another embodiment, each rotor stage may include 8 permanent magnets inserted into corresponding 8 rotor teeth, as shown in FIG. 14.

In one embodiment, the number and shape of permanent magnets attached to each rotor iron core of its associated rotor stage may be the same. The permanent magnets on each rotor stage may be arranged in the same manner. In another embodiment, each of the number of permanent magnets, shape of permanent magnets and arrangement of permanent magnets on one rotor stage may be different than that of permanent magnets on other rotor stages.

Many modifications and other example embodiments set forth herein will come to mind to the reader knowledgeable in the technical field to which these example embodiments pertain to having the benefit of the teachings presented in the foregoing descriptions and the associated drawings. Therefore, it is to be understood that the embodiments are not to be limited to the specific ones disclosed and that modifications and other embodiments are intended to be included within the scope of the claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims.

1. A three-phase PMAC motor, comprising:
a rotor, the rotor including a rotor iron core, a plurality of rotor teeth, a plurality of rotor slots each formed between two adjacent rotor teeth, and a plurality of permanent magnets disposed in respective rotor slots and attached on the rotor iron core, the plurality of permanent magnets forming at least 8 pairs of magnet poles with one or two permanent magnets being associated with one pair of magnetic poles; and
a stator, the stator including a stator iron core, a plurality of stator teeth protruding inwardly from inner surface of the stator iron core, three groups of armature windings wound around each of the stator teeth, and a plurality of stator slots formed between two adjacent stator teeth, each group of armature windings being associated with one electrical phase, an electrical phase shift existing between each two armature windings.

2. The three-phase PMAC motor of claim 1, wherein the permanent magnets are arranged with polarities alternatively changed along the circumferential direction in the rotor iron core to achieve a magnetic field, and wherein two permanent magnets form a pair of magnetic poles.

3. The three-phase PMAC motor of claim 1, wherein a plurality of rotor slots are formed in the rotor iron core with adjacent rotor slots being separated by a rotor tooth, wherein the plurality of permanent magnets are disposed into respective rotor slots with polarities disposed on radial direction, each permanent magnet being associated with a pair of magnetic poles.

4. The three-phase PMAC motor of claim 3, wherein each permanent magnet is separated from its adjacent rotor teeth by forming spaces between sidewalls of each permanent magnet and its adjacent rotor teeth, and filling at least a portion of each space with non-magnetic materials.

5. The three-phase PMAC motor of claim 4, wherein the non-magnetic materials comprise one of stainless steel, aluminum, copper and plastic sheet.

6. The three-phase PMAC motor of claim 3, wherein the plurality of permanent magnets is attached on the rotor iron core by inserting a plurality of bolts into respective recesses that are formed on sidewalls of each permanent magnet and its adjacent rotor teeth.

7. The three-phase PMAC motor of claim 3, wherein the plurality of permanent magnets is attached on the rotor iron core by employing a magnetic cap on outer surface of each permanent magnet.

8. The three-phase PMAC motor of claim 7, wherein the magnetic cap is attached to the rotor iron core by forming spaces between sidewalls of each magnetic cap and its adjacent rotor teeth, and filling at least a portion of the spaces with non-magnetic materials.

9. The three-phase PMAC motor of claim 8, wherein the magnetic cap is made of soft magnetic materials.

10. The three-phase PMAC motor of claim 1, wherein shape of the permanent magnets is one of rectangular, T-shape, trapezoid, triangular, polygon and arc.

11. The three-phase PMAC motor of claim 1, wherein sidewalls of the permanent magnets have curves.

12. The three-phase PMAC motor of claim 1, wherein the rotor has two or more rotor stages in longitudinal direction with an electrical phase shift between two adjacent rotor stages, each rotor stage including a rotor iron core to which a plurality of permanent magnets is attached.

13. The three-phase PMAC motor of claim 12, wherein the electrical phase shift is 180°.

14. The three-phase PMAC motor of claim 12, wherein each rotor stage includes at least 8 permanent magnets.
